(19) United States
(12) Patent Application Publication
(10) Pub. No.: US 2007/0022157 A1
(43) Pub. Date: Jan. 25, 2007

(54) Audio-visual indication of instant message priority

(75) Inventors: Fonda J. Daniels, Cary, NC (US); Ruthie D. Lyle, Durham, NC (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation

(21) Appl. No.: 11/186,358

(22) Filed: Jul. 21, 2005

(51) Int. Cl. G06F 15/16

(52) U.S. Cl. 709/204

(57) ABSTRACT

Embodiments of the present invention address deficiencies of the art in respect to message prioritization and provide a method, system and computer program product for audio-visual presentation of message prioritization in a human-to-human collaborative environment. In one embodiment, a data processing system for audio-visual presentation of prioritized messages in a collaborative environment can include a human-to-human collaborative system client, a data store of prioritized messages, and a table correlating display characteristics of user interface elements with message priorities for messages referenced by the data store. The system also can include prioritization and visualization logic which can include program code enabled to render each of the user interface elements with corresponding display characteristics consonant with priorities assigned to individual messages displayed in each of the user interface elements.

### BACKGROUND OF THE INVENTION

1. Field of the Invention

The present invention relates to the field of collaborative computing and more particularly to instant messaging and chat systems.

2. Description of the Related Art

Real time communications systems provide a substantial enhancement over more traditional, asynchronous communications systems. Electronic mail delivery systems, the prototypical asynchronous communications systems, in its time represented a giant leap forward in respect to global interpersonal communications. Prior to electronic mail, individuals primarily communicated via telephone, facsimile and post. With electronic mail, however, individuals expect near instant delivery of text, and even imagery, audio and video, without incurring the delay typical of the postal system, or the expense associated with telephony and fax technologies.

Despite the ubiquity of electronic mail, asynchronous communications systems lack several elements common in the realm of real time communications systems. In particular, the seemingly instant delivery of a message cannot be experienced in the world of electronic mail. In a real-time society, the minor latencies associated with electronic mail often cannot be suitable for the task at hand where a real-time conversation will be required in addressing a problem or performing a collaborative task. More importantly, often the feel and nature of a “conversation” as it is known to human beings only can be approximated through real time communications where the participants to a conversation feel the spontaneity of an exchange of ideas, much as is the case in a live, face-to-face conversation.

The recent rapid development of the Internet has led to advanced modes of synchronous, real-time collaboration able to fulfill the real-time communicative requirements of the modem computing participant. Using the Internet as a backbone, individuals worldwide can converge in real-time in cyberspace to share ideas, documents and images in a manner not previously possible through conventional telephony and video conferencing. To facilitate collaboration over the Internet, a substantial collection of technologies and protocols have been assembled to effectively deliver audio, video and data over the single data communications medium of the Internet. These technologies include several human-to-human collaborative environments such as instant messaging and persistent chat rooms.

In an instant messaging or persistent chat room environment, a messaging session can be requested by a collaborator, and upon acceptance of the request, a human-to-human collaborative session can be established in which real-time or near real-time messages can be exchanged as between the collaborators party to the session. The exchange of messages can continue until the session is terminated. Additional requests for collaborative sessions can result in the establishment of different environments which can execute concurrently albeit separately from one another. As it will be recognized, managing multiple collaborative sessions at once can become more difficult as the number of sessions increases.

Hence, as human-to-human collaborative environments, instant messaging and chat room technologies provide an efficient and useful method for personal and business communications. Inefficiencies can be introduced, however, when a user receives several messages for different collaborative environments that must be managed according to the priority of the message. In this regard, determining which messages in which collaborative environments should be addressed first can often relate to the messages which are urgent in nature and which messages are not urgent in nature. Accordingly, prioritization schemes have been developed which prioritize incoming messages across multiple collaborative environments. Yet, identifying messages which have been prioritized according to a prioritization scheme can be difficult in that all incoming messages can appear uniform despite the different priorities assigned to each incoming message.

### BRIEF SUMMARY OF THE INVENTION

Embodiments of the present invention address deficiencies of the art in respect to message prioritization and provide a novel and non-obvious method, system and computer program product for audio-visual presentation of message prioritization in a human-to-human collaborative environment. In one embodiment, a data processing system for audio-visual presentation of prioritized messages in a collaborative environment can include a human-to-human collaborative system client, a data store of prioritized messages, and a table correlating display characteristics of user interface elements with message priorities for messages referenced by the data store. The system also can include prioritization and visualization logic coupled to the human-to-human collaborative system client, the data store of prioritized messages and the table. The prioritization and visualization logic can include program code enabled to render each of the user interface elements with corresponding display characteristics consonant with priorities assigned to individual messages displayed in each of the user interface elements.

In another embodiment, a method for audio-visually presenting prioritized message in a collaborative environment can include determining a priority for a received message, selecting a display characteristic consonant with the priority, configuring a user interface element to display the received message, assigning the display characteristic to the user interface element, and rendering the user interface element. Optionally, the method can include audibly playing back information from a data store of prioritized messages. Audibly playing back information from a data store of prioritized messages can include audibly playing back a synopsis of prioritized messages in the data store.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a system for audio-visual presentation of prioritized messages in a collaborative environment;

FIG. 2 is a pictorial illustration of a user interface configured for audio-visual presentation of prioritized messages in a collaborative environment; and,

FIG. 3 is a flow chart illustrating a process for audio-visual presentation of prioritized messages in a collaborative environment.

### DETAILED DESCRIPTION OF THE INVENTION

Embodiments of the present invention provide a method, system and computer program product for audio-visual presentation of prioritized messages in a collaborative environment. In accordance with an embodiment of the present invention, different display characteristics can be assigned to different message priorities in a collaborative environment. The display characteristics can include color, for example. Thereafter, the prioritization of incoming messages in a human-to-human collaborative system can be identified and the corresponding display characteristics can be applied to the user interface elements displaying different ones of the incoming messages. Optionally, the prioritization can be audibly played back as well. In this way, the display characteristics of the user interface elements and the playing back of the prioritization can be used to determine the priority of different received messages.

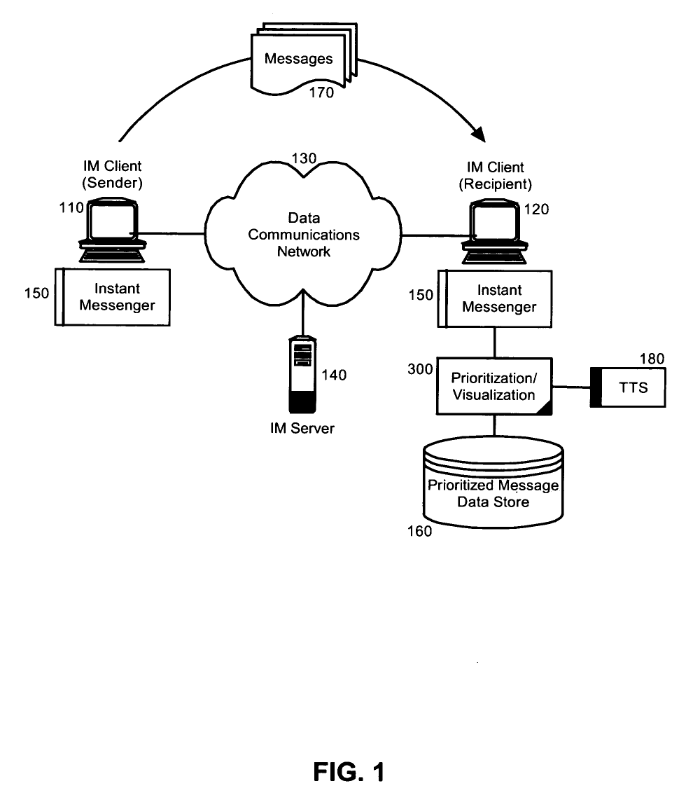

In more detailed explanation of an embodiment of the present invention, FIG. 1 is a schematic illustration of a system for audio-visual presentation of prioritized message in a collaborative environment. The system can include an instant messaging client 110 configured with instant messaging logic 150. The instant messaging client 110 can be communicatively linked to another instant messaging client 120 also configured with instant messaging logic 150. In this way, the instant messaging client 10 (acting as a sender) can transmit instant messages over the data communications network 130 to the instant messaging client 120 (acting as a recipient). Optionally, an instant messaging server 140 can facilitate the exchange of instant messages between the instant messaging clients 110, 120, although the instant messaging clients 110, 120 need not reside in the same instant messaging network and the instant messaging clients 110, 120 can reside in different instant messaging networks.

The instant messenger 150 can be configured to include prioritization and visualization logic 300. Additionally, a prioritized message data store 160 can be coupled to the instant messenger 150, such as a log of prioritized messages. The prioritization and visualization logic 300 can include program code enabled to prioritize different messages 170 received in the instant messenger 150. The prioritization can be recorded in the prioritized message data store 160 and performed by queue management logic (not shown) coupled to the prioritization and visualization logic 300 for incoming messages 170. Rules governing the prioritization of the messages 170 can include, for instance, prioritizing messages 170 according to the time when the messages 170 are received, according to the presence of the message source in a buddy list, according to a relationship hierarchy for the source, and according to a category or role assigned to the source and prioritized with respect to other sources of the messages 170.

Notably, the prioritization and visualization logic 300 further can include program code enabled to associate display characteristics with prioritizations assigned to different messages 170. For example, the prioritization and visualization logic 300 can assign different colors or color schemes to messages of different priorities. The assigned display characteristics, in turn, can be applied to user interface elements associated with the different messages. For instance, the each window used to display a message can be decorated with a visual display characteristic corresponding to the priority assigned to the message displayed in the window. In this way, one viewing the window can recognize the priority of the message displayed within the window without first reading the content of the message.

Optionally, a text-to-speech engine 180 can be coupled to the prioritization and visualization logic 300. The text-to-speech engine 180 can read the content of the prioritized message data store 160 and can audibly play back information regarding the prioritization of the messages 170. The information can include both a detailed play-back of the messages in the prioritized message data store 160, or an audio synopsis of the message in the prioritized message data store 160. The audio synopsis of the prioritized messages can include, for example, “You have 5 instant messages, two are marked important and the others are marked FYI. The two priority messages were received 10:30 AM and 10:31 AM from Lamont and Amanda.”

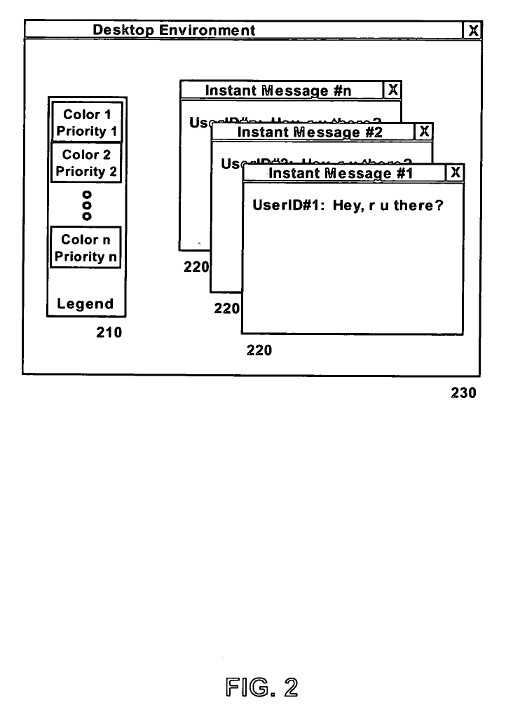

Turning now to FIG. 2, a pictorial illustration is shown of a user interface configured for audio-visual presentation of prioritized messages in a collaborative environment. The user interface can include a desktop environment 230 which can include a stand-alone collaborative environment, or a dedicated human-to-human collaborative system. The desktop environment 230 can include a multiplicity of windows 220 acting as user interface elements associated with incoming messages. Each of the windows 220 can be configured with display characteristics consonant with the priority of the message displayed therein. For example, the color of the window frame for each of the windows 220 can vary according to the priority of a contained message. To facilitate the interpretation of the display characteristics of the windows 220 a legend 210 can be provided in the desktop environment 230.

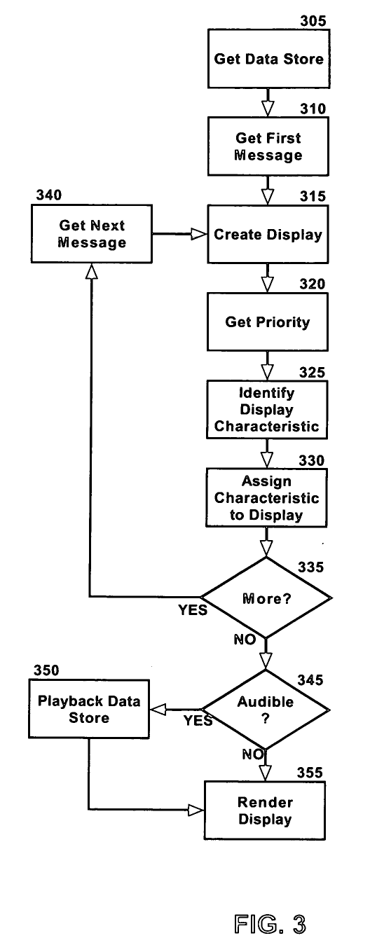

In further illustration, FIG. 3 is a flow chart illustrating a process for audio-visual presentation of prioritized messages in a collaborative environment. Beginning in block 305, the prioritization data store can be retrieved and parsed and in block 310, a first message can be retrieved for processing. In block 315, a user interface display element such as a window can be created and associated with the message. In block 320, a priority can be identified for the message and, in block 325, a display characteristic corresponding to the priority can be identified and applied in block 330 to the user interface element. Subsequently, in decision block 335, if more messages remain to be processed, in block 340 the next message can be retrieved and the process can repeat through block 315.

When no further messages remain to be processed in decision block 335, in decision block 345, it can be determined whether an audible playback of the data store is desirable. If so, in block 350, the data store can be played back. For example, an audio synopsis the data store can be played back, or a detailed accounting of the content of the data store can be played back. Subsequently, in block 355, the display can be rendered with the user interface elements, each having the assigned display characteristics which are consonant with the priority of associated messages.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A data processing system for audio-visual presentation of prioritized messages in a collaborative environment, comprising:
a human-to-human collaborative system client;
a data store of prioritized messages;
a table correlating display characteristics of user interface elements with message priorities for messages referenced by said data store; and,
prioritization and visualization logic coupled to said human-to-human collaborative system client, said data store of prioritized messages and said table, said prioritization and visualization logic comprising program code enabled to render each of said user interface elements with corresponding display characteristics consonant with priorities assigned to individual messages displayed in each of said user interface elements.

2. The data processing system of claim 1, further comprising a text-to-speech engine coupled to said data store of prioritized message and configured to audibly playback information derived from said data store.

3. The data processing system of claim 1, wherein said human-to-human collaborative system client is an instant messenger.

4. The data processing system of claim 1, wherein said human-to-human collaborative system client is a persistent chat room client.

5. The data processing system of claim 1, wherein said display characteristics comprise color.

6. The data processing system of claim 1, wherein said user interface elements comprise display windows.

7. The data processing system of claim 6, further comprising a legend of display characteristics disposed in a desktop environment hosting said display windows.

8. A method for audio-visually presenting prioritized messages in a collaborative environment, the method comprising:
determining a priority for a received message;
selecting a display characteristic consonant with said priority;
configuring a user interface element to display said received message;
assigning said display characteristic to said user interface element; and,
rendering said user interface element.

9. The method of claim 8, wherein said selecting a display characteristic consonant with said priority, comprises selecting a color determined to be consonant with said priority.

10. The method of claim 8, further comprising audibly playing back information from a data store of prioritized messages.

11. The method of claim 10, wherein said audibly playing back information from a data store of prioritized messages, comprises audibly playing back a synopsis of prioritized messages in said data store.

12. A computer program product comprising a computer usable medium having computer usable program code for audio-visually presenting prioritized messages in a collaborative environment, said computer program product including:
computer usable program code for determining a priority for a received message;
computer usable program code for selecting a display characteristic consonant with said priority;
computer usable program code for configuring a user interface element to display said received message;
computer usable program code for assigning said display characteristic to said user interface element; and,
computer usable program code for rendering said user interface element.

13. The computer program product of claim 12, wherein said computer usable program code for selecting a display characteristic consonant with said priority, comprises computer usable program code for selecting a color determined to be consonant with said priority.

14. The computer program product of claim 12, further comprising computer usable program code for audibly playing back information from a data store of prioritized messages.

15. The computer program product of claim 14, wherein said computer usable program code for audibly playing back information from a data store of prioritized messages, comprises computer usable program code for audibly playing back a synopsis of prioritized messages in said data store.
